(19) United States
(12) Patent Application Publication
(10) Pub. No.: US 2022/0027876 A1
(43) Pub. Date: Jan. 27, 2022

(54) CONSOLIDATING PERSONAL BILL

(71) Applicant: International Business Machines Corporation, Armonk, NY (US)

(72) Inventors: Xin Zhou, Beijing (CN); Lijun Mei, Beijing (CN); Qi Cheng Li, Beijing (CN); Hao Chen, Beijing (CN); Xue Han, Beijing (CN); Zhuoxuan Jiang, Shanghai (CN)

(21) Appl. No.: 16/939,695

(22) Filed: Jul. 27, 2020

(51) Int. Cl. G06Q 20/14; G06N 20/00

(52) U.S. Cl. CPC G06Q 20/14; G06N 20/00

(57) ABSTRACT

Aspects of the present invention disclose a method for consolidating of a plurality of personal bills from diverse financial sources to reflect the payments, expenses, and balances without duplication. The method includes one or more processors parsing a plurality of bills of a user, the plurality of bills including bills with varying formats. The method further includes identifying a set of bills of the plurality of bills of the user, the set of bills including related bills based at least in part on a prebuilt rule. The method further includes determining a correlation of one or more items of respective bills of the set of bills of the user based at least in part on a machine learning algorithm. The method further includes generating a consolidated bill, from the set of bills of the user, based at least in part on the determined correlation of the one or more items.

### BACKGROUND OF THE INVENTION

The present invention relates generally to cognitive analytics, and more particularly to consolidating a plurality of bills of the user from various sources.

In recent years, mobile payments applications have grown, and users receive multiple transaction statements and/or bills from multiple financial sources. As a result, challenges exist in summarize the bills to reflect the actual income, expense, and balance of user accounts.

Cognitive analytics combines the use of cognitive computing and analytics. Cognitive computing combines artificial intelligence and machine-learning algorithms, in an approach that attempts to reproduce the behavior of the human brain. Analytics is the scientific process of transforming data into insights for making better decisions. Cognitive analytics applies intelligent technologies to bring unstructured data sources within reach of analytics processes for decision making.

Machine learning is the scientific study of algorithms and statistical models that computer systems use to perform a specific task without using explicit instructions, relying on patterns and inference instead. Machine learning is seen as a subset of artificial intelligence. Machine learning algorithms build a mathematical model based on sample data, known as “training data,” in order to make predictions or decisions without being explicitly programmed to perform the task. Machine learning algorithms are used in a wide variety of applications.

Labeled data is data that has been annotated and formatted with one or multiple labels to train machine learning models. This process of attaching labels to unstructured data is most commonly known as data annotation or data labeling. There are many forms of data labeling commonly used in machine learning today. After obtaining a labeled dataset, machine learning models/algorithms can be applied to the data so that unlabeled data can be presented to the model and a likely label is predicted for the unlabeled data.

### SUMMARY

Aspects of the present invention disclose a method, computer program product, and system for consolidating of a plurality of personal bills from diverse financial sources to reflect the payments, expenses, and balances without duplication. The method includes one or more processors parsing a plurality of bills of a user, the plurality of bills including bills with varying formats. The method further includes one or more processors identifying a set of bills of the plurality of bills of the user, the set of bills including related bills based at least in part on a prebuilt rule. The method further includes one or more processors determining a correlation of one or more items of respective bills of the set of bills of the user based at least in part on a machine learning algorithm. The method further includes one or more processors generating a consolidated bill, from the set of bills of the user, based at least in part on the determined correlation of the one or more items. The embodiments of the present invention manages personal bills of a user from various sources in a centralized way to consolidate the personal bills of the user to reflect the actual income, expense, and/or balance without duplication from the personal bills.

In another embodiment, the method further includes one or more processors generating a set of training data based on the set of bills of the plurality of bills of the user. The method further includes one or more processors training an implicit correlation model using the set of training data. Accordingly, embodiments of the present invention can operate to eliminate manual labelling of the data used to train the implicit correlation model to generate a consolidated bill.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program, within the data processing environment of FIG. 1, for consolidation of a plurality of personal bills from diverse financial sources to reflect the actual payment, expense, and balance without duplication, in accordance with embodiments of the present invention.

FIG. 3 is a depiction of a unified bill model for activity or knowledge corresponding to bills of a user, in accordance with embodiments of the present invention.

FIG. 4A is a depiction of collected personal bills of a user, in accordance with embodiments of the present invention.

FIG. 4B is a depiction of collected personal bills of a user of FIG. 4A after bill program 200 identifies correlated instances of expenses, in accordance with embodiments of the present invention.

FIG. 5 is a depiction of textual data bill program 200 extracts from collected personal bills of a user of FIG. 4A, in accordance with embodiments of the present invention.

FIG. 6 is a depiction of collected personal bills of a user after bill program 200 identifies correlated instances of an expense and corresponding refund, in accordance with embodiments of the present invention.

FIG. 7 is a depiction of collected personal bills of a user after bill program 200 identifies correlated instances of corresponding duplicate expenses in the collected bills, in accordance with embodiments of the present invention.

FIG. 8 is a block diagram of components of the client device and server of FIG. 1, in accordance with an embodiment of the present invention.

### DETAILED DESCRIPTION

Embodiments of the present invention allow for consolidation of a plurality of personal bills from diverse financial sources to reflect the actual payment, expense, and balance without duplication. Embodiments of the present invention parse a plurality of bills of a user in different formats from various sources to a unified bill model. Embodiments of the present invention perform a cross-bill record analysis of the plurality of bills. Additional embodiments of the present invention generate a consolidated personal bill based on the plurality of bills. Further embodiments of the present invention utilize feedback of the user to update the cross-bill record analysis of the plurality of the bills.

Some embodiments of the present invention recognize that a user receives a plurality of personal bills from multiple financial sources and summarizing the plurality bills to reflect the actual income, expense and balance is challenging. For example, challenges can arise due to differences in formats, corresponding charges/expense, and refunds in related bills. Additionally, a user may receive personal bills from multiple financial sources (e.g., online payment platforms, various lenders, banking institutions, credit card companies, etc.), but summarizing the personal bills to reflect the actual income, expense, and balance is a challenge. In one scenario, a user may elect to pay credit card expenses with a designated online payment platform. If the user purchased a laptop from an online shop and paid with the credit card, the expense will appear in the designated online payment platform bill and credit card bill, then the expense item in the designated online payment platform bill and the credit card bill may be reflected different (e.g., description, time, etc.).

Various embodiments of the present invention remedy such challenges by generating a consolidated personal bill based on the plurality of bills utilizing a trained correlation model. Also, embodiments of the present invention utilize explicit correlation rules to identify a set of correlated bills of the plurality of bills and generate training samples for the trained correlation model of using the set of correlated bills.

Embodiments of the present invention recognize that cognitive models and/or machine learning algorithms require manual labelling of data used to train the models and/or algorithms. Various embodiments of the present invention can eliminate manual labelling of the data used to train the models and/or algorithms to generate a consolidated bill. Additionally, various embodiments of the present invention can operate to increase efficiency of a computer system by reducing the amount of memory resources utilized to store the plurality of bills for various programs of the computer system by removing the plurality of bills after the consolidated bill is generated.

Implementation of embodiments of the invention may take a variety of forms, and exemplary implementation details are discussed subsequently with reference to the Figures.

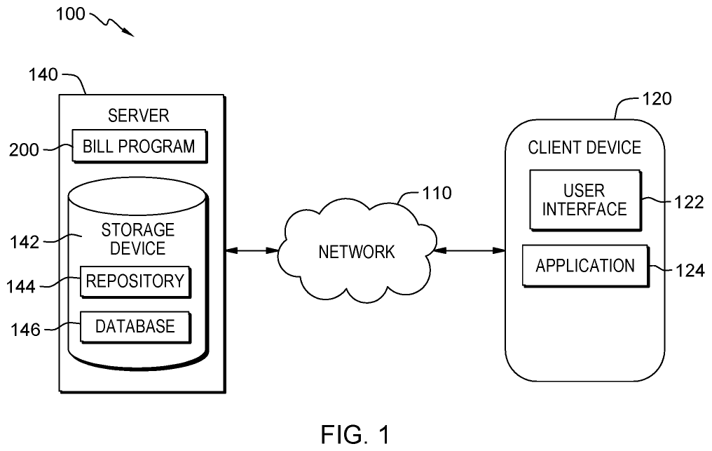

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

The present invention may contain various accessible data sources, such as repository 144 and database 146, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Bill program 200 enables the authorized and secure processing of personal data. Bill program 200 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Bill program 200 provides information regarding personal data and the nature (e.g., type, scope, purpose, duration, etc.) of the processing. Bill program 200 provides the user with copies of stored personal data. Bill program 200 allows the correction or completion of incorrect or incomplete personal data. Bill program 200 allows the immediate deletion of personal data.

Distributed data processing environment 100 includes server 140 and client device 120, all interconnected over network 110. Network 110 can be, for example, a telecommunications network, a local area network (LAN) a municipal area network (MAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include voice, data, and video information. In general, network 110 can be any combination of connections and protocols that will support communications between server 140 and client device 120, and other computing devices (not shown) within distributed data processing environment 100.

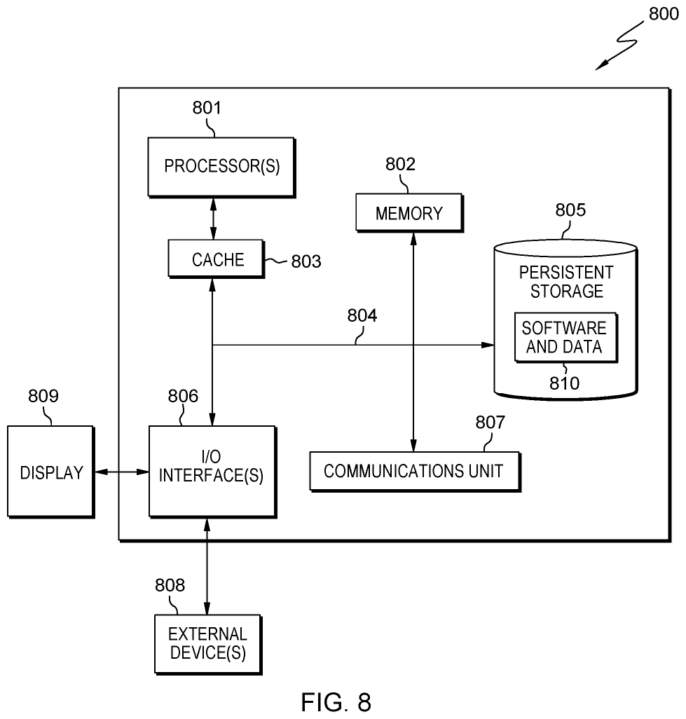

Client device 120 can be one or more of a laptop computer, a tablet computer, a smart phone, smart watch, a smart speaker, virtual assistant, or any programmable electronic device capable of communicating with various components and devices within distributed data processing environment 100, via network 110. In general, client device 120 represents one or more programmable electronic devices or combination of programmable electronic devices capable of executing machine readable program instructions and communicating with other computing devices (not shown) within distributed data processing environment 100 via a network, such as network 110. Client device 120 may include components as depicted and described in further detail with respect to FIG. 8, in accordance with embodiments of the present invention.

Client device 120 includes user interface 122 and application 124. In various embodiments of the present invention, a user interface is a program that provides an interface between a user of a device and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122 is a script or application programming interface (API).

Application 124 is a computer program designed to run on client device 120. An application frequently serves to provide a user with similar services accessed on personal computers (e.g., web browser, playing music, e-mail program, or other media, etc.). In one embodiment, application 124 is mobile application software. For example, mobile application software, or an “app,” is a computer program designed to run on smart phones, tablet computers and other mobile devices. In another embodiment, application 124 is a web user interface (WUI) and can display text, documents, web browser windows, user options, application interfaces, and instructions for operation, and include the information (such as graphic, text, and sound) that a program presents to a user and the control sequences the user employs to control the program. In another embodiment, application 124 is a client-side application of bill program 200.

In various embodiments of the present invention, server 140 may be a desktop computer, a computer server, or any other computer systems, known in the art. In general, server 140 is representative of any electronic device or combination of electronic devices capable of executing computer readable program instructions. Server 140 may include components as depicted and described in further detail with respect to FIG. 8, in accordance with embodiments of the present invention.

Server 140 can be a standalone computing device, a management server, a web server, a mobile computing device, or any other electronic device or computing system capable of receiving, sending, and processing data. In one embodiment, server 140 can represent a server computing system utilizing multiple computers as a server system, such as in a cloud computing environment. In another embodiment, server 140 can be a laptop computer, a tablet computer, a netbook computer, a personal computer (PC), a desktop computer, a personal digital assistant (PDA), a smart phone, or any programmable electronic device capable of communicating with client device 120 and other computing devices (not shown) within distributed data processing environment 100 via network 110. In another embodiment, server 140 represents a computing system utilizing clustered computers and components (e.g., database server computers, application server computers, etc.) that act as a single pool of seamless resources when accessed within distributed data processing environment 100.

Server 140 includes storage device 142, repository 144, database 146, and bill program 200. Storage device 142 can be implemented with any type of storage device, for example, persistent storage 805, which is capable of storing data that may be accessed and utilized by client device 120 and server 140, such as a database server, a hard disk drive, or a flash memory. In one embodiment storage device 142 can represent multiple storage devices within server 140.

In various embodiments of the present invention, storage device 142 stores numerous types of data which may include repository 144 and/or database 146. Repository 144 may be a central location in which data is stored and managed. For example, repository 144 includes explicit correlation rules and data associated with implicit correlation training sample data. Database 146 may represent one or more organized collections of data stored and accessed from server 140. For example, database 146 includes a plurality of bills of a user, unified bill models, consolidated bills, user feedback, etc. In one embodiment, data processing environment 100 can include additional servers (not shown) that host additional information that accessible via network 110.

Bill program 200 can consolidate a plurality of personal bills from diverse financial sources to reflect the actual payment, expense, and balance without duplication. Additionally, bill program 200 can generate training samples to train an implicit correlation model based on explicit correlation rules without manual labelling. In one embodiment, bill program 200 utilizes data of storage device 142 to parse a bill of client device 120. For example, bill program 200 uses natural language processing (NLP) techniques to identify and extract textual data (e.g., unstructured text) that includes information (e.g., payments, expenses, balances, bill cycles, etc.) of a bill of a client device 120 of the user that relates to attributes of a unified bill model. In this example, NLP techniques include sentence splitting, tokenization, POS tagging, chunking, parsing, anaphora resolution, optical character recognition, etc.

In another embodiment, bill program 200 correlates a plurality of bills of client device 120. For example, bill program 200 generates a set of bills of a mobile device (e.g., client device 120) of a user based on corresponding textual data extracted from the plurality of bills. In another embodiment, bill program 200 generates a consolidated bill of a plurality of bills of client device 120. For example, bill program 200 combines payments, refunds, and/or expenses of corresponding items (e.g., extracted textual data) of a set of bills of a plurality of bills of a user to reflect balances of each of the corresponding items across the plurality of bills and generates a consolidated bill utilizes a format of a unified bill model of a database (e.g., database 146). In yet another embodiment, bill program 200 collects feedback of a user via client device 120 that corresponds to a consolidated bill. For example, bill program 200 uses feedback of a user to optimize the machine learning algorithm utilize to correlate a plurality of bills of a user.

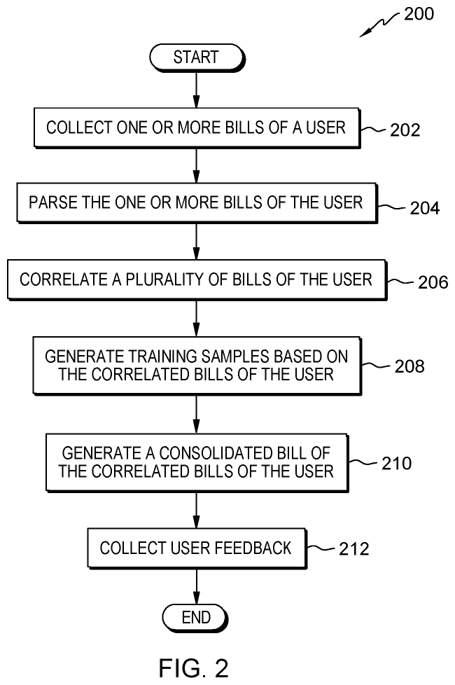

FIG. 2 is a flowchart depicting operational steps of bill program 200, a program that consolidates of a plurality of personal bills from diverse financial sources to reflect the actual payment, expense, and balance without duplication, in accordance with embodiments of the present invention. In one embodiment, bill program 200 initiates in response to a user connecting client device 120 to bill program 200 through network 110. For example, bill program 200 initiates in response to a user registering (e.g., opting-in) a laptop (e.g., client device 120) with bill program 200 via a WLAN (e.g., network 110). In another embodiment, bill program 200 is a background application that continuously monitors client device 120. For example, bill program 200 is a client-side application (e.g., application 124) that initiates upon booting of a laptop (e.g., client device 120) of a user and monitors data of the laptop.

In step 202, bill program 200 collects one or more bills of a user. In one embodiment, bill program 200 utilizes application 124 to retrieve a bill of a user. For example, bill program 200 utilizes a client-side application (e.g., application 124) that functions as a document importer of a laptop (e.g., client device 120) of a user to transmit a plurality of bills of the user to a database (e.g., database 146). In this example, the plurality of bills of the database may be stored in various formats (e.g., Extensible Markup Language (XML), JavaScript Object Notation (JSON), comma-separated values (CSV), etc.) from various sources (e.g., banks, creditors, utilities companies, etc.). Additionally, bill program 200 collects the plurality of bills that include unpaid balances, payments, and/or refunds. In an addition, bill program 200 can collect bills a user defines (e.g., monthly, billing cycle, defined timeframe, etc.).

In another embodiment, bill program 200 builds a unified bill model based on database 146. For example, bill program 200 utilizes a plurality of bills of a database (e.g., database 146) as a corpus to generate a unified bill model (e.g., entity-relationship) specific to the user (i.e., a domain specific to the user). In this example, bill program 200 maps each concept identified in the plurality of bills of the database into an entity, attribute, or relationship of the unified bill model.

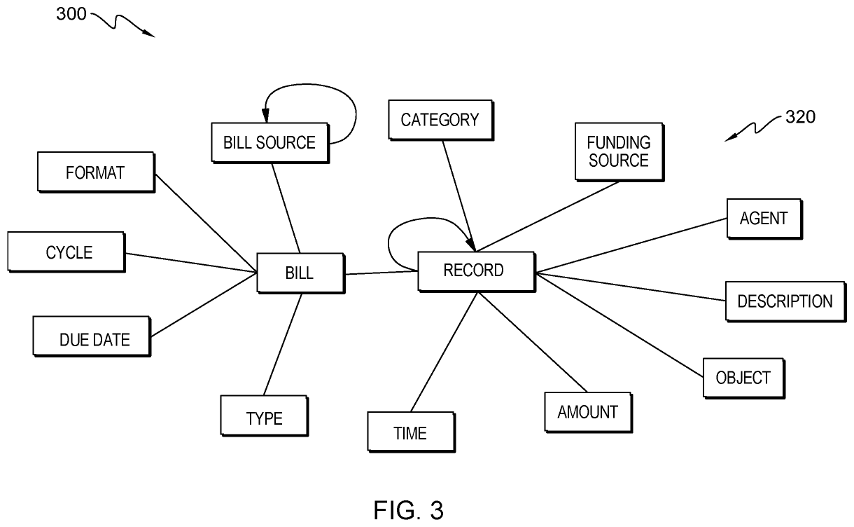

FIG. 3 depicts domain 300, which is an illustration of a specified sphere of model for activity or knowledge corresponding to bills of a user, that bill program 200 utilizes to parse bills of the user. Domain 300 includes model 320, the instance of which includes a visual representation of a graph-like structure based on a corpus of bills of the user of database 146, that uses structural information of concepts across a plurality of bills of the corpus, and links concepts of the plurality of bills together. In an example embodiment with respect to FIG. 3, bill program 200 utilizes one or more bills of database 146 to generate a model instance according to model 320 of domain 300. In this example embodiment, bill program 200 extracts textual data of the one or more bills of database 146 and identifies entities, relations, and attributes of the textual data of the one or more bills. Additionally, each attribute of model 320 corresponds to an item of the one or more bills of database 146. Furthermore, model 320 includes relations between attributes and entities of the one or more bills of database 146.

In step 204, bill program 200 parses the one or more bills of the user. In one embodiment, bill program 200 identifies information of a bill of database 146. For example, bill program 200 can utilize a unified bill model to identify information and map the information of a plurality of bills to a schema concept type (e.g., entity, attribute, relationship, etc.) of the unified bill model. In this example, bill program 200 parses the plurality of bills of various sources with differing formats to the unified bill model and extracts information associated with the schema concept type from the plurality of bills. In an alternative example, bill program 200 identifies that a user input a bill into a designated bill folder of an email application (e.g., application 124) of a laptop (e.g., client device 120) and parses the bill using the unified bill model. In this example, bill program 200 correlates the parsed information with a schema concept type of the unified bill model.

In another example, bill program 200 utilizes optical character recognition to convert images of typed, handwritten, or printed text into machine-encoded text from a scanned bill or a photo of a bill. In this example, bill program 200 tokenizes the converted text of the scanned or photo of the bill. Additionally, bill program 200 parses a unified bill model to identify tokenized text of the bill that correlates to a schema concept type (e.g., entity, attribute, relationship, etc.) of the unified bill model and outputs the identified text in various formats (e.g., XML, JSON, CSV, etc.).

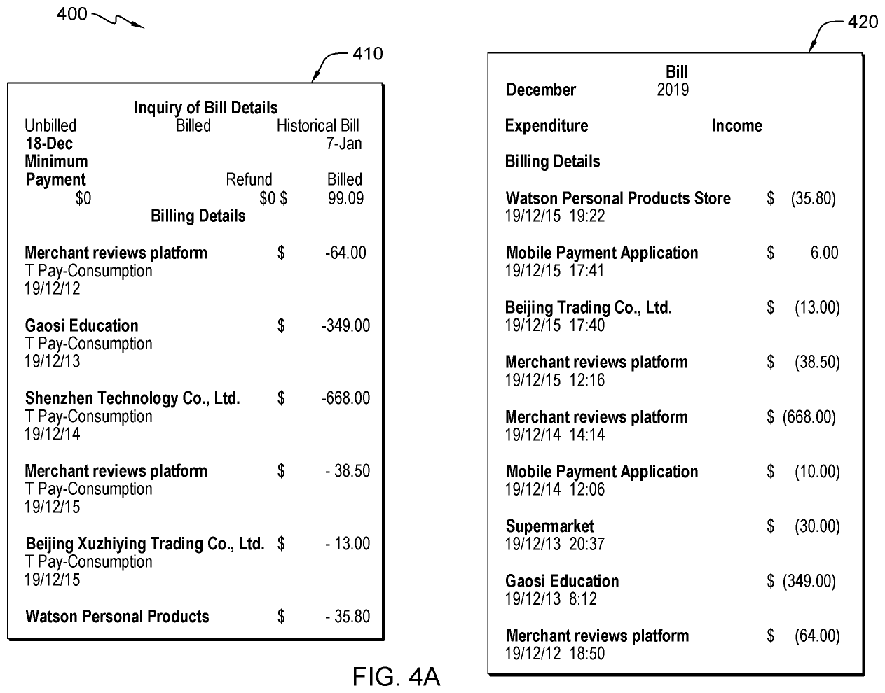

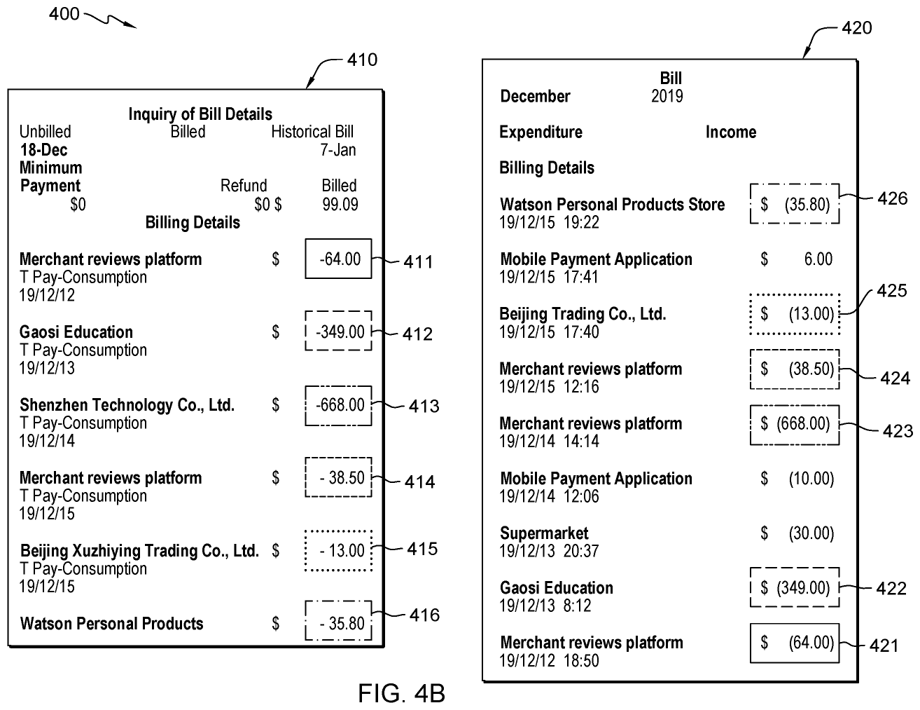

FIG. 4A depicts bill collection 400, which is an illustration of collected personal bills of a user stored in database 146. Bill collection 400 includes bill 410 and bill 420. In an example embodiment with respect to FIG. 4A, bill program 200 parses bill 410 and bill 420 using model 320 of FIG. 3 to identify various information (e.g., category, time, amount, object, bill cycle, etc.) of bill 410 and bill 420 and corresponding values (e.g., textual data of line items of bills) that correspond to a schema concept type (e.g., entity, attribute, relationship, etc.) of model 320. In this example embodiment, bill program 200 extracts the identified schema concept types and the values of bill 410 and bill 420.

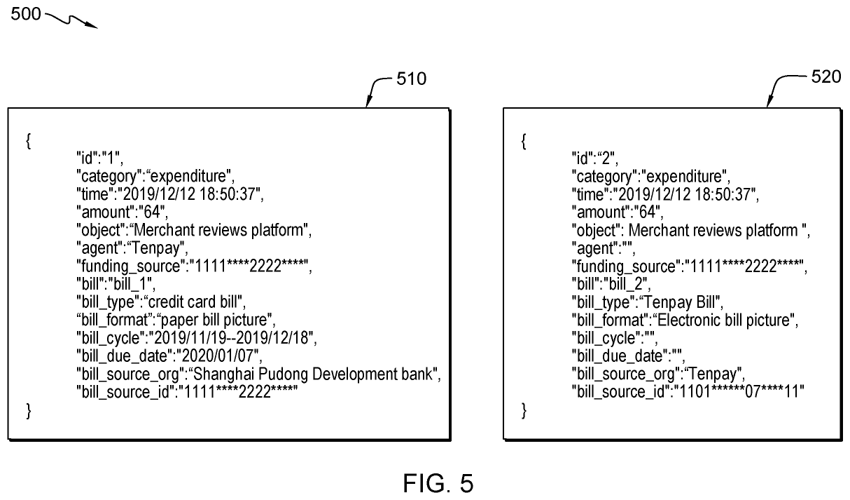

FIG. 5 depicts bill collection 400, which is an illustration of collected personal bills of a user stored in database 146. Bill collection 400 includes bill 510 and bill 520, which correspond to bill 410 and bill 420 of FIG. 4A respectively. In an example embodiment with respect to FIG. 5, bill program 200 formats extracted identified schema concept types (e.g., category, object, funding source, type, etc.) and corresponding values (e.g., line items, payments, expenses, of bill 410 and bill 420 with respect to model 320. In this example embodiment, bill program 200 uses schema concept types of model 320 to identify line items and corresponding values (e.g., information) of bill 410 and bill 420, which are different formats and extracts the information of bill 410 and bill 420 corresponding to the schema concept types to generate corresponding unified bills (e.g., bill 510 and bill 520). Specifically, in this example embodiment, bill program 200 extracts textual data (e.g., Merchant reviews platform) in bill 410 and bill 420 of FIG. 4A corresponding to the object schema concept type of model 320 and inputs the textual data in bill 510 and bill 520 respectively. In addition, bill program 200 utilizes model 320 to generate one or more unified bills of the one or more bills of database 146.

In step 206, bill program 200 correlates a plurality of bills of the user. In one embodiment, bill program 200 identifies related bills of a plurality of bills of a user. Also, bill program 200 utilizes explicit correlation rules of repository 144 and a machine learning algorithm trained to correlate bills of a user. For example, bill program 200 performs a cross-bill record analysis of bills of a user. In this example, bill program 200 identifies related bills based on prebuilt rules of a repository (e.g., repository 144) and generates a training set of correlated records to train an implicit correlation model. Additionally, bill program 200 utilizes the implicit correlation model to identify implicit linkage between items (e.g., textual data, line items, etc.) of the correlated bills of a record, which represents transactions included in the correlated bills of a business, an individual or any other organization. Also, bill program 200 utilizes the implicit correlation model to identify a root expense of the correlated bills of the record using the structure of a unified bill model.

In another example, bill program 200 uses prebuilt rules (e.g., explicit correlation rules) to identify two or more bills that are related. In this example, the prebuilt rules criteria can include bill fields (e.g., identified text corresponding to schema concept types), matching method (exact, fuzzy, etc.), scoring method (e.g., average, highest, minimum, weighted, etc.), and/or match threshold (e.g., minimum match score needed for the bill field to be considered a match). Additionally, bill program 200 compares a bill field in a first bill to a corresponding bill field in a second bill to determine whether the fields match (i.e., in exact matching if the two bill fields match, the match score is one hundred (100) on a scale of zero (0) to one hundred (100), but if the two bill fields do not match, the score is zero (0) on a scale of zero (0) to one hundred (100)).

In an example embodiment, referring to FIG. 5, bill program 200 utilizes a prebuilt rule of repository 144 that includes the category, bill cycle, amount, object, time, and funding source bill fields in the defined criteria. In this example, bill program 200 traverses a plurality of bills of database 146 and identifies a match between bill 510 and bill 520 based on the defined criteria of the prebuilt rule. Referring now to FIG. 4A, bill program 200 can retrieve bill 410 and bill 420 from database 146 based on the identified match.

In another example, bill program 200 uses an implicit correlation model (e.g., a machine learning algorithm trained) to identify correlations in textual data of bills retrieved with respect to a prebuilt rule. In this example, bill program 200 utilizes the implicit correlation model to correlate one or more bills with one or more records using textual data of the one or more bills mapped to schema concept types of a unified bill model. Additionally, bill program 200 utilizes the implicit correlation model to identify a single expense recorded in multiple bills in different way, an expense in one bill and a relative refund in another bill, and/or implicit duplicate expenses in different bills.

In another example, bill program 200 utilizes NLP techniques and machine learning algorithm to identify an expense of a first retrieved bill that corresponds to an expense of a second retrieved bill in the textual data of the respective bills retrieved with respect to a prebuilt rule (e.g., explicit correlation rule). In this example, bill program 200 utilizes a machine learning algorithm to determine whether an expense of a first bill correlates to an expense of a second bill based on textual data of one or more fields of retrieved bills that correspond to a schema concept type.

Referring now to FIG. 5, in an example embodiment bill program 200 inputs bill 510 and bill 520) into an implicit correlation model (e.g., machine learning algorithm, neural network, etc.) to determine whether a value corresponding to the “amount” of bill 520 corresponds to an expense of a value corresponding to the “amount” of bill 510. FIG. 4B depicts bill collection 400, which is an illustration of collected personal bills of a user stored in database 146. Bill collection 400 includes bill 410, which includes item 412, item 413, item 414, item 415, and item 416, and bill 420, which includes item 421, item 422, item 423, item 424, item 425, and item 426. Item 411 through item 416 and item 421 through item 426 can be credits or expenses of a respective bill, hereinafter referred to as items. FIG. 4B is a depiction of correlated instances of items of bill 410 and bill 420. In this example embodiment with respect to FIG. 4B, bill program 200 correlates a plurality of expenses of bill 410 and bill 420 using the aforementioned methodology. Thus, bill program 200 determines that item 411 and item 421 correspond to a common expense.

In another example, bill program 200 utilizes NLP techniques and machine learning algorithms to identify an expense of a first retrieved bill in the textual data of bills, which are retrieved with respect to a prebuilt rule, and a corresponding refund of the expense in a second retrieved bill. In this example, bill program 200 utilizes NLP techniques to identify textual data of an expense of a first bill that indicates that a user has returned an item corresponding with the expense of the first bill and information (e.g., object, date, amount, source etc.) corresponding to the first expense. Additionally, bill program 200 utilizes NLP techniques to identify information (e.g., object, date, amount, source etc.) of textual data of a second bill to determine whether a relationship exists between the first expense and a second expense of the second bill. Additionally, bill program 200 can utilize a machine learning algorithm (e.g., implicit correlation model) to identify an expense and relative refund based on comparing corresponding values of the first and second bills mapped to schema concept types of a unified bill model to determine a correlation between the expense of the first bill and a credit (e.g., relative refund) of the second bill.

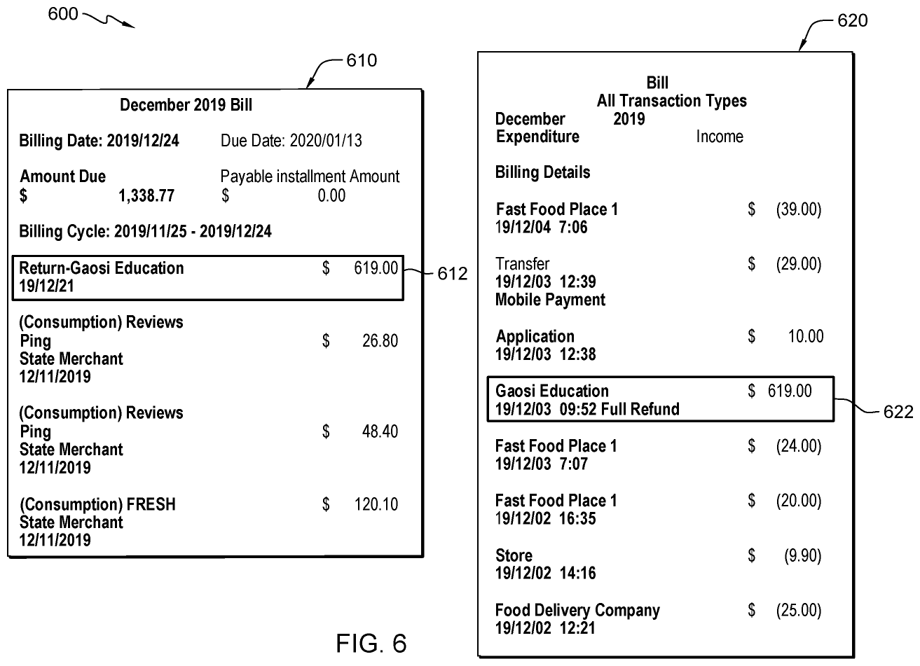

FIG. 6 depicts bill collection 600, which is an illustration of collected personal bills of a user stored in database 146 retrieved in response to a prebuilt rule. Bill collection 600 includes bill 610, line item 612, bill 620, and line item 622. In an example embodiment with respect to FIG. 6, bill program 200 parses bill 610 and bill 620 using model 320 of FIG. 3 to identify various information (e.g., category, time, amount, object, bill cycle, etc.) of line item 612 of bill 610 and determines that an item corresponding to line item 612 has been returned based on textual data (e.g., “Return”). In this example embodiment, bill program 200 identifies line item 622 based on a correlation in amount (e.g., $619.00) object (e.g., Gaosi Education) and additional information of the textual data (e.g., “Full Refund”).

In yet another example, bill program 200 utilizes NLP techniques and machine learning algorithm to identify an expense in the textual data of a first retrieved bill that is duplicated in textual data of a second retrieved bill. In this example, bill program 200 inputs a extracted information (e.g., agent, funding source, bill source identifiers, categories, amounts, etc.) of the first and second retrieved bills into a machine learning algorithm (e.g., implicit correlation model) to identify a relationship between expenses of with the same “amount” to determine whether the expenses are duplicates (i.e., determines whether the expense is the result of a single transaction that is being recorded in both bills).

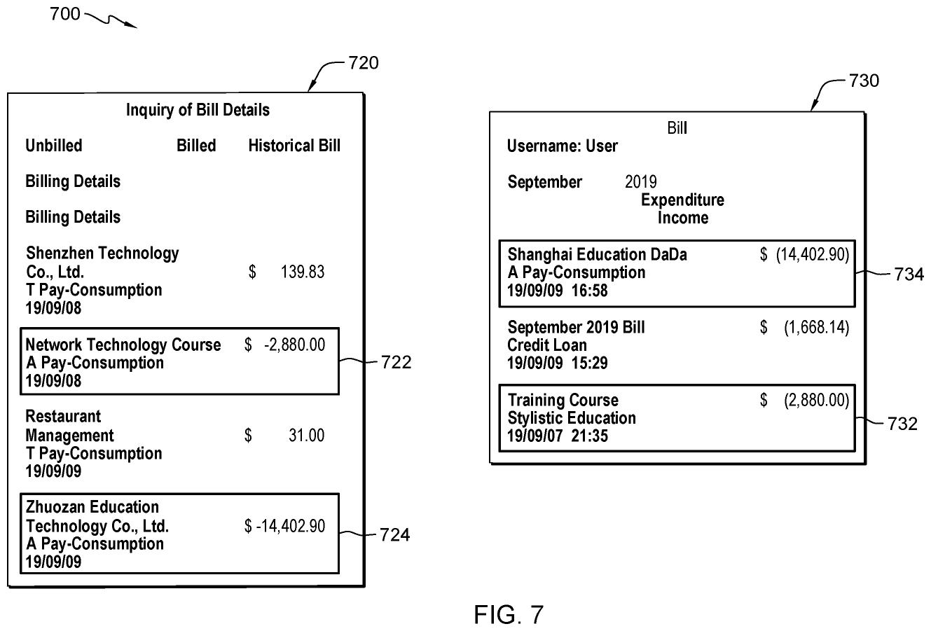

FIG. 7 depicts bill collection 700, which is an illustration of collected personal bills of a user stored in database 146 retrieved in response to a prebuilt rule. Bill collection 700 includes credit card bill 720, expense 722, expense 724, A-Pay transaction history 730, transaction 732, and transaction 734. In an example embodiment with respect to FIG. 7, a user linked a card corresponding to A-Pay transaction history 730 to pay expenses for a credit card (e.g., expense 722 and expense 724 of credit card bill 720). As a result, a transaction to pay an expense of the credit card bill will appear in A-Pay transaction history 730 and credit card bill 720 and different values (e.g., objects) are assigned to each expense, respectively. In an example embodiment, bill program 200 inputs information (e.g., amounts, dates, agents, categories, etc.) corresponding to line items of credit card bill 720 A-Pay and transaction history 730 into an implicit correlation model and determines that expense 722 is implicitly linked to transaction 732 and expense 724 is implicitly linked to transaction 734.

In step 208 bill program 200 generates training samples based on the correlated bills of the user. In one embodiment, bill program 200 uses data of repository 144 and database 146 to generate a set of training data for an implicit correlation model to perform one or more correlation tasks. For example, bill program 200 utilizes a plurality bills of a database (e.g., database 146) and collected feedback of a user (discussed in step 212) to create a dataset (e.g., training data) to train an implicit correlation model. In this example, bill program 200 uses a prebuilt rule (e.g., explicit correlation rules) of a repository (e.g., repository 144) to correlate bills and generate one or more training samples (e.g., the dataset). Additionally, bill program 200 uses feedback of a user to create a validation dataset to evaluate the implicit correlation model fit on the training samples while tuning the hyperparameters the implicit correlation model. Furthermore, bill program 200 utilization of the prebuilt rule can eliminate labelling from the process of generating the dataset for training data and the corresponding time effort when preparing data to build the implicit correlation model.

In another example, bill program 200 can create a dataset (e.g., training data) to train an implicit correlation model using correlated bills of a plurality bills of a database (e.g., database 146). In this example, bill program 200 partitions the dataset into a training dataset, test dataset, and validation dataset. Additionally, bill program 200 uses the partitioned data sets to iteratively train and validate the implicit correlation model. Also, bill program 200 can use feedback from a user to update or generated the validation dataset, which is utilized to provide an unbiased evaluation of the implicit correlation model fit on the training dataset while tuning model hyperparameters.

In step 210, bill program 200 generates a consolidated bill of the correlated bills of the user. In one embodiment, bill program 200 utilizes correlated bills of database 146 of a user to generate a consolidated bill. For example, bill program 200 utilizes a unified bill model (e.g., graph-like structure) to identify a root expense record (e.g., uppermost node of a graph-like structure) for a set of correlated bills of a user. In this example, bill program 200 utilizes correlations of one or more pairs of corresponding expenses and payments as well as expenses and refunds to generate a balance that corresponds to the one or more pairs (i.e., determine the difference between the sum of expense entries and the sum of payment and/or refund entries in the set of correlated bills during a billing cycle). Additionally, bill program 200 uses the generated balances, expenses, credits, and payments to generate a consolidated bill corresponding to each of the items of the set of correlated bills that is absent of duplication.

In another embodiment, bill program 200 generates a consolidated bill of a plurality of bills of client device 120. For example, bill program 200 combines payments, refunds, and/or expenses of corresponding items (e.g., extracted textual data) of a set of bills of a plurality of bills of an email folder (e.g., application 124) a user to generate a consolidated bill. In this example, bill program 200 stores the generated bill in a database (e.g., database 146) and removes the set of bills of the plurality of bills of the email folder. As a result, bill program 200 increases available memory resources utilized to store the set of bills. Additionally, bill program 200 increases availability of processing resources of a computing system by eliminating the substantial number of request to the computing system by the user to retrieve each bill of the set of bills of the plurality in order to manually consolidate the set of bills.

In step 212, bill program 200 collects user feedback. In various embodiment of the present invention user feedback can be a user added pair of items in correlated bills that is not recognized by the implicit correlation model or a user rejected pair of items recognized by the correlation implicit model. In one embodiment, bill program 200 validates a generated consolidated bill. For example, bill program 200 collects data corresponding to an evaluation of an implicit correlation model utilized to generate a consolidated bill for accuracy. In this example, bill program 200 collects feedback of a user to determine the accuracy of the model to identify one or more pairs of corresponding expenses and payments as well as expenses and refunds. Additionally, the accuracy corresponding to identifying single expenses recorded in multiple bills in various formats. In another example, bill program 200 can utilize cross-validation techniques to train an implicit correlation model utilized to generate a consolidated bill, where user feedback is used to update a training dataset.

FIG. 8 depicts computer system 800, which is representative of client device 120 and server 140, in accordance with an illustrative embodiment of the present invention. It should be appreciated that FIG. 8 provides only an illustration of one implementation and does not imply any limitations with regard to the environments in which different embodiments may be implemented. Many modifications to the depicted environment may be made.

FIG. 8 includes processor(s) 801, cache 803, memory 802, persistent storage 805, communications unit 807, input/output (I/O) interface(s) 806, and communications fabric 804. Communications fabric 804 provides communications between cache 803, memory 802, persistent storage 805, communications unit 807, and input/output (I/O) interface(s) 806. Communications fabric 804 can be implemented with any architecture designed for passing data and/or control information between processors (such as microprocessors, communications and network processors, etc.), system memory, peripheral devices, and any other hardware components within a system. For example, communications fabric 804 can be implemented with one or more buses or a crossbar switch.

Memory 802 and persistent storage 805 are computer readable storage media. In this embodiment, memory 802 includes random access memory (RAM). In general, memory 802 can include any suitable volatile or non-volatile computer readable storage media. Cache 803 is a fast memory that enhances the performance of processor(s) 801 by holding recently accessed data, and data near recently accessed data, from memory 802.

Program instructions and data (e.g., software and data 810) used to practice embodiments of the present invention may be stored in persistent storage 805 and in memory 802 for execution by one or more of the respective processor(s) 801 via cache 803. In an embodiment, persistent storage 805 includes a magnetic hard disk drive. Alternatively, or in addition to a magnetic hard disk drive, persistent storage 805 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 805 may also be removable. For example, a removable hard drive may be used for persistent storage 805. Other examples include optical and magnetic disks, thumb drives, and smart cards that are inserted into a drive for transfer onto another computer readable storage medium that is also part of persistent storage 805. Software and data 810 can be stored in persistent storage 805 for access and/or execution by one or more of the respective processor(s) 801 via cache 803. With respect to client device 120, software and data 810 includes application 124. With respect to server 140, software and data 810 includes bill program 200, repository 144, and database 146.

Communications unit 807, in these examples, provides for communications with other data processing systems or devices. In these examples, communications unit 807 includes one or more network interface cards. Communications unit 807 may provide communications through the use of either or both physical and wireless communications links. Program instructions and data (e.g., software and data 810) used to practice embodiments of the present invention may be downloaded to persistent storage 805 through communications unit 807.

I/O interface(s) 806 allows for input and output of data with other devices that may be connected to each computer system. For example, I/O interface(s) 806 may provide a connection to external device(s) 808, such as a keyboard, a keypad, a touch screen, and/or some other suitable input device. External device(s) 808 can also include portable computer readable storage media, such as, for example, thumb drives, portable optical or magnetic disks, and memory cards. Program instructions and data (e.g., software and data 810) used to practice embodiments of the present invention can be stored on such portable computer readable storage media and can be loaded onto persistent storage 805 via I/O interface(s) 806. I/O interface(s) 806 also connect to display 809.

Display 809 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
parsing, by one or more processors, a plurality of bills of a user, the plurality of bills including bills with varying formats;
identifying, by one or more processors, a set of bills of the plurality of bills of the user, the set of bills including related bills based at least in part on a prebuilt rule;
determining, by one or more processors, a correlation of one or more items of respective bills of the set of bills of the user based at least in part on a machine learning algorithm; and
generating, by one or more processors, a consolidated bill, from the set of bills of the user, based at least in part on the determined correlation of the one or more items.

2. The method of claim 1, further comprising:
generating, by one or more processors, a unified bill model based at least in part on the plurality of bills of the user with varying formats.

3. The method of claim 1, further comprising:
defining, by one or more processors, a criteria of the prebuilt rule, wherein the criteria includes bill fields.

4. The method of claim 1, further comprising:
generating, by one or more processors, a set of training data based on the set of bills of the plurality of bills of the user; and
training, by one or more processors, an implicit correlation model using the set of training data.

5. The method of claim 1, further comprising:
determining, by one or more processors, a relationship of one or more item pairs of the set of bills of the plurality of bills of the user based at least in part on utilizing an implicit correlation model.

6. The method of claim 1, further comprising:
collecting, by one or more processors, correlation feedback of the user; and
modifying, by one or more processors, weights of an implicit correlation model based on the correlation feedback of the user.

7. The method of claim 1, wherein generating the consolidated bill of the set of bills of the user based at least in part on the determined correlation of the one or more items, further comprises:
identifying, by one or more processors, a root of a unified bill model corresponding to a record that includes the set of bills of the user;
identifying, by one or more processors, one or more item pairs of the set of bills corresponding to the record of the root of the unified bill model; and
summarizing, by one or more processors, the identified one or more item pairs to indicate actual incomes, expenses, and balances of the set of bills corresponding to the record of the root.

8. The method of claim 7, further comprising:
determining, by one or more processors, a balance of the identified one or more item pairs corresponding to the record of the root of the unified bill model based at least in part on the actual incomes and expenses, wherein incomes includes payments and refunds.

9. The method of claim 1, wherein determining the correlation of one or more items of respective bills of the set of bills of the user based at least in part on the machine learning algorithm, further comprising:
identifying, by one or more processors, a first expense of a first bill of the set of bills that corresponds to a second expense of a second bill of the set of bills, wherein a format of the first expense differs from a format of the second expense;
identifying, by one or more processors, a refund of the second bill of the set of bills that corresponds to the first expense of the first bill of the set of bills; and
identifying, by one or more processors, duplicate expenses in two or more bills of the set of bills.

10. A computer program product comprising:
one or more computer readable storage media and program instructions stored on the one or more computer readable storage media, the program instructions comprising:
program instructions to parse a plurality of bills of a user, the plurality of bills including bills with varying formats;
program instructions to identify a set of bills of the plurality of bills of the user, the set of bills including related bills based at least in part on a prebuilt rule;
program instructions to determine a correlation of one or more items of respective bills of the set of bills of the user based at least in part on a machine learning algorithm; and
program instructions to generate a consolidated bill, from the set of bills of the user, based at least in part on the determined correlation of the one or more items.

11. The computer program product of claim 10, further comprising program instructions, stored on the one or more computer readable storage media, to:
generate a unified bill model based at least in part on the plurality of bills of the user with varying formats.

12. The computer program product of claim 10, further comprising program instructions, stored on the one or more computer readable storage media, to:
define a criteria of the prebuilt rule, wherein the criteria includes bill fields.

13. The computer program product of claim 10, further comprising program instructions, stored on the one or more computer readable storage media, to:
generate a set of training data based on the set of bills of the plurality of bills of the user; and
train an implicit correlation model using the set of training data.

14. The computer program product of claim 10, further comprising program instructions, stored on the one or more computer readable storage media, to:
determine a relationship of one or more item pairs of the set of bills of the plurality of bills of the user based at least in part on utilizing an implicit correlation model.

15. The computer program product of claim 10, further comprising program instructions, stored on the one or more computer readable storage media, to:
collect correlation feedback of the user; and
modify weights of an implicit correlation model based on the correlation feedback of the user.

16. The computer program product of claim 10, wherein program instructions to generate the consolidated bill of the set of bills of the user based at least in part on the determined correlation of the one or more items, further comprise program instructions to:
identify a root of a unified bill model corresponding to a record that includes the set of bills of the user;
identify one or more item pairs of the set of bills corresponding to the record of the root of the unified bill model; and
summarize the identified one or more item pairs to indicate actual incomes, expenses, and balances of the set of bills corresponding to the record of the root.

17. The computer program product of claim 10, wherein program instructions determine the correlation of one or more items of respective bills of the set of bills of the user based at least in part on the machine learning algorithm, further comprise program instructions to:
identify a first expense of a first bill of the set of bills that corresponds to a second expense of a second bill of the set of bills, wherein a format of the first expense differs from a format of the second expense;
identify a refund of the second bill of the set of bills that corresponds to the first expense of the first bill of the set of bills; and
identify duplicate expenses in two or more bills of the set of bills.

18. A computer system comprising:
one or more computer processors;
one or more computer readable storage media; and
program instructions stored on the computer readable storage media for execution by at least one of the one or more processors, the program instructions comprising:
program instructions to parse a plurality of bills of a user, the plurality of bills including bills with varying formats;
program instructions to identify a set of bills of the plurality of bills of the user, the set of bills including related bills based at least in part on a prebuilt rule;
program instructions to determine a correlation of one or more items of respective bills of the set of bills of the user based at least in part on a machine learning algorithm; and
program instructions to generate a consolidated bill, from the set of bills of the user, based at least in part on the determined correlation of the one or more items.

19. The computer system of claim 18, further comprising program instructions, stored on the one or more computer readable storage media for execution by at least one of the one or more processors, to:
generate a unified bill model based at least in part on the plurality of bills of the user with varying formats.

20. The computer system of claim 18, further comprising program instructions, stored on the one or more computer readable storage media for execution by at least one of the one or more processors, to:
define a criteria of the prebuilt rule, wherein the criteria includes bill fields.

21. The computer system of claim 18, further comprising program instructions, stored on the one or more computer readable storage media for execution by at least one of the one or more processors, to:
generate a set of training data based on the set of bills of the plurality of bills of the user; and
train an implicit correlation model using the set of training data.

22. The computer system of claim 18, further comprising program instructions, stored on the one or more computer readable storage media for execution by at least one of the one or more processors, to:
determine a relationship of one or more item pairs of the set of bills of the plurality of bills of the user based at least in part on utilizing an implicit correlation model.

23. The computer system of claim 18, further comprising program instructions, stored on the one or more computer readable storage media for execution by at least one of the one or more processors, to:
collect correlation feedback of the user; and
modify weights of an implicit correlation model based on the correlation feedback of the user.

24. The computer system of claim 18, wherein program instructions to generate the consolidated bill of the set of bills of the user based at least in part on the determined correlation of the one or more items, further comprise program instructions to:
identify a root of a unified bill model corresponding to a record that includes the set of bills of the user;
identify one or more item pairs of the set of bills corresponding to the record of the root of the unified bill model; and
summarize the identified one or more item pairs to indicate actual incomes, expenses, and balances of the set of bills corresponding to the record of the root.

25. The computer system of claim 18, wherein program instructions to determine the correlation of one or more items of respective bills of the set of bills of the user based at least in part on the machine learning algorithm, further comprise program instructions to:
identify a first expense of a first bill of the set of bills that corresponds to a second expense of a second bill of the set of bills, wherein a format of the first expense differs from a format of the second expense;
identify a refund of the second bill of the set of bills that corresponds to the first expense of the first bill of the set of bills; and
identify duplicate expenses in two or more bills of the set of bills.
